(19) United States
(12) Patent Application Publication
(10) Pub. No.: US 2012/0176677 A1
(43) Pub. Date: Jul. 12, 2012

(54) DEVICE FOR MECHANICAL CLEANING THE SPECTACLES GLASSES

(76) Inventors: Denis TRAUDICH, Pers-Jussy (FR); Josef Formánek, Nezvestice (CZ)

(21) Appl. No.: 13/343,253

(22) Filed: Jan. 4, 2012

(30) Foreign Application Priority Data
Jan. 6, 2011 (CZ) 2011-7

(51) Int. Cl. G02C 13/00

(52) U.S. Cl. 359/509; 359/507

(57) ABSTRACT

The invention is the device for mechanical cleaning the glasses of the spectacles with the frontal brush. On the stand at least one frontal brush is mounted which is joined to the rotary movement source. On the stand the frontal brushes are located at a distance corresponding to the spacing of the spectacles glasses. The frontal brushes are arranged opposite each other mutually.

### FIELD OF ENGINEERING

The invention is the device for cleaning the spectacles glasses by means of a frontal brush.

### STATE OF THE PRIOR ART

As a rule the spectacles glasses are cleaned by means of a serviette, sometimes impregnated by active substance. Usually, such procedure does not remove impurities from notches and folds between a glass and a rim. Likewise, cleaning the whole spectacles by submerging thereof into a solution is well known. Although this procedure removes the impurities from both glasses and notches and folds, it requires subsequent drying dependent on used solution. A means determined to clean the spectacles glasses is known, as described in the patent deed CN 201285468 Y. This means consists of a pull-out frontal brush located in a bushing. The efficiency of manual frontal brush acting on the spectacles glass is limited considerably due to which it is not suitable to remove greater soiling.

In making optical lenses where the machined semi-finished glass products must be cleaned between individual operations the cleaning is performed with frontal brushes which are mounted movably on the machine frame for this purpose and driven with electromotors, as described in JP 4579622. Such realization is suitable for industrial utilization only.

On the contrary, the device for cleaning spectacles glasses, described in the deed U.S. Pat. No. 5,222,258 is suitable to be used by a consumer because of its mobility. U-shaped carrier arms are ended by opposite brushes of which one can be fitted with a drive. The device, solved in such way, is determined for individual cleaning the spectacles by the consumer itself. It does not match professional application e.g. in completing the spectacles or services of opticians.

### SUBSTANCE OF THE SOLUTION

The device for mechanical cleaning spectacles glasses with a frontal brush, according to the invention, has frontal brushes mounted on a stand and joined to a rotary movement source. On the stand the final brushes are arranged in pair at a distance corresponding to the spacing of spectacles glasses. In this way both spectacles glasses can be cleaned effectively at the same time.

With the frontal brushes arranged opposite each other mutually, both spectacles glasses can be cleaned on both sides simultaneously.

It is suitable to locate a guide with a spectacles holder adjustable as for its height. After being located in the holder which guarantees correct limitation thereof with respect to the frontal brushes, the spectacles can be cleaned more perfectly.

This is similar in the embodiment in which a tiltable arm is attached to the stand by means of a joint and equipped with a spectacles holder where the holder with the spectacles moves inclinably.

In order to increase the efficiency of the cleaning process, it is suitable to place compressed air nozzles above the frontal brushes. Before inserting the spectacles glasses between the frontal brushes, due to compressed air acting the dust impurities are removed which could scratch the glasses due to frontal brushes movement. After the spectacles glasses having been pulled out of the reach of the frontal brushes, the rests of the active substance, if used, can be removed.

### DESCRIPTION OF THE FIGURES ON THE DRAWINGS

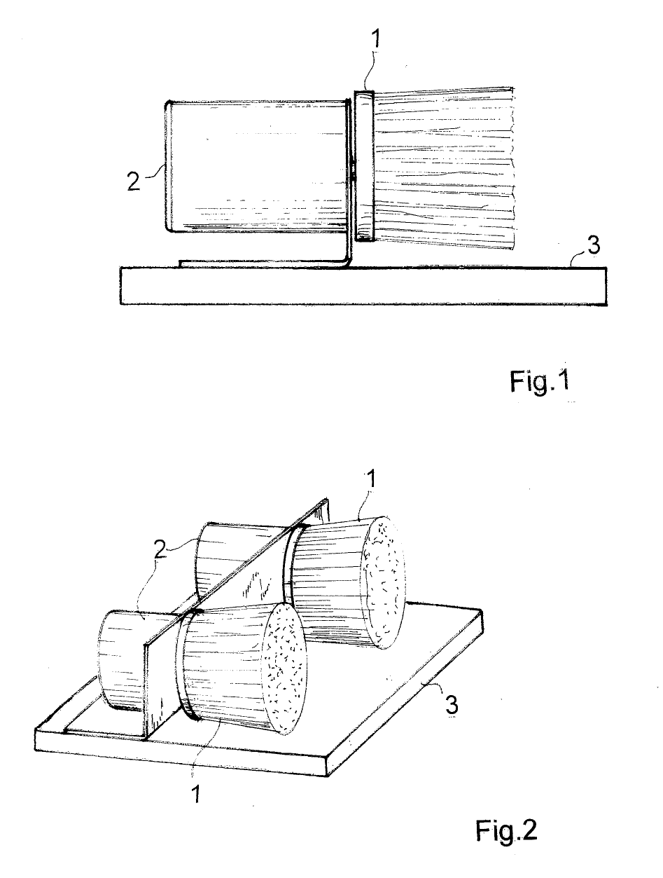

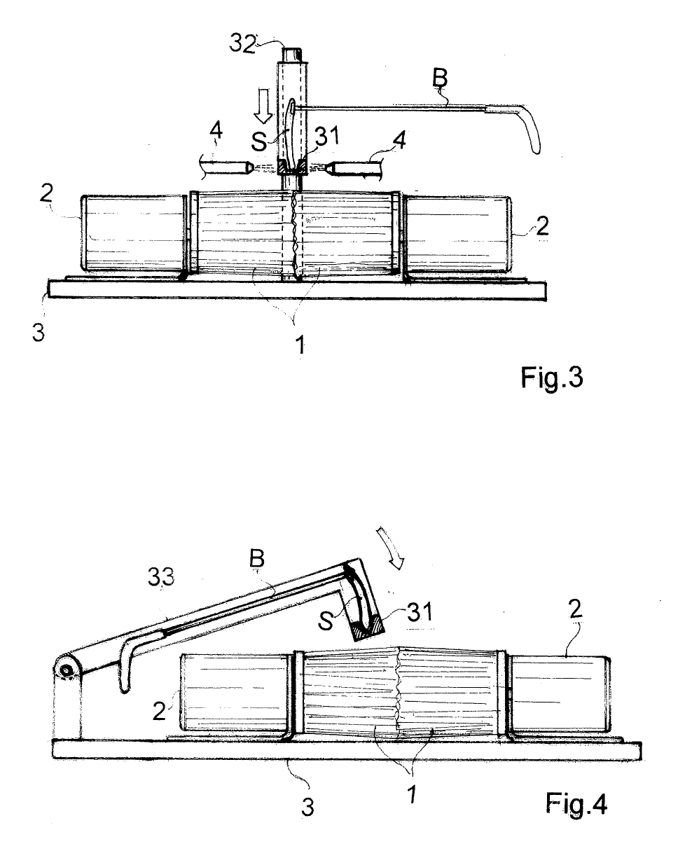

On FIG. 1 the side elevation of the frontal brush is represented which is placed on the stand and joined to the rotary movement source; on FIG. 2 a pair of frontal brushes is shown which are distanced mutually by the spectacles glasses spacing; the embodiment with the spectacles holder, the height of which on the guide can be adjusted, is represented on FIG. 3 and the realization with the spectacles holder located on a inclinable arm is represented in FIG. 4.

### EXEMPLARY REALIZATION OF THE INVENTION

Each frontal brush 1 is placed on the stand 3 and is joined to the rotary movement source 2 which is e.g. an electromotor. The frontal brushes 1 are located on the stand 3 at the distance corresponding to the spacing of the spectacles glasses S as shown in FIG. 2. In FIGS. 3 and 4 the pairs of frontal brushes 1 are mounted on the stand 3 at the distance corresponding to the spacing of the spectacles glasses S and are arranged opposite each other mutually. In these realizations, consisting of pairs of the frontal brushes 1 arranged opposite each other mutually, the holder 31 is determined for the spectacles B. In a simpler realization there is not any holder 31 and the spectacles B can be inserted between the pairs of the opposite brushes 1 directly. In the realization, represented on FIG. 3, the holder is adjusted on the inclinable arm 33. In the embodiment, shown on FIG. 4, the holder 31 is set on the inclinable arm 33. The spectacles B are inserted into the holder 31. By vertical movement along the guide 32 or by tilting the arm 33 the glasses S get between the frontal brushes 1. With the compressed air nozzles 4 placed above the frontal brushes 1 the glasses S can be cleared from dust particles by means of compressed air before inserting thereof between the frontal glasses 1. The glasses S are cleaned by rotary movement of the frontal brushes 1. With cleaning means applied simultaneously on the frontal brushes 1, it is suitable, with the holder 31 elevated together with the spectacles B to let the compressed air act from the nozzles 4 again in order to clear the glasses S from superfluous cleaning means and dry them at the same time. The cleaning solution can be spread by means of the nozzles 4 as well.

1. The device for mechanical cleaning the glasses of spectacles with a frontal brush where the frontal brushes, joined to a rotary movement source, are placed on a stand wherein the frontal brushes are arranged on the stand in pair at the distance corresponding to the spacing of the spectacles glasses.

2. The device according to the claim 1, wherein to the pair of the frontal brushes a second pair of the fontal brushes is arranged opposite each other.

3. The device according to the claim 1, that wherein on the stand the holder of the spectacles is arranged adjustably as for height on the guides.

4. The device according the claims 1, that wherein to the stand the inclinable arm is fitted with a joint, said arm being equipped with the holder of the spectacles.

5. The device according some of the claims 1, wherein the compressed air nozzle is placed above the frontal brush.

6. The device according to the claim 2, wherein on the stand the holder of the spectacles is arranged adjustably as for height on the guides.

7. The device according the claims 2, wherein to the stand the inclinable arm is fitted with a joint, said arm being equipped with the holder of the spectacles.

8. The device according the claims 3, wherein to the stand the inclinable arm is fitted with a joint, said arm being equipped with the holder of the spectacles.

9. The device according some of the claims 2, wherein the compressed air nozzle is placed above the frontal brush.

10. The device according some of the claims 3, wherein the compressed air nozzle is placed above the frontal brush.

11. The device according some of the claims 4, wherein the compressed air nozzle is placed above the frontal brush.
